(19) United States
(12) Patent Application Publication
(10) Pub. No.: US 2010/0089256 A1
(43) Pub. Date: Apr. 15, 2010

(54) PRESS AND A RELATIVE METHOD FOR PRESSING FOOD PRODUCTS

(75) Inventors: Massimo MELANDRI, Lugo (IT); Filippo Melandri, Bologna (IT); Giuseppe Melandri, Lugo (IT); Matteo Comandini, Cesena (IT)

Correspondence Address: BROWDY AND NEIMARK, P.L.L.C.;624 NINTH STREET, NW, SUITE 300, WASHINGTON, DC, 20001-5303, US

(73) Assignee: DIEMME S.P.A., Lugo (IT)

(21) Appl. No.: 12/641,613

(22) Filed: Dec. 18, 2009

(30) Foreign Application Priority Data
Apr. 23, 2009 (IT) RE2009A000036

(51) Int. Cl. B30B 9/02; B30B 9/26; B30B 9/06

(52) U.S. Cl. 100/37; 100/130; 100/110

(57) ABSTRACT

A press and a method for pressing food products, the press comprising a compartment (10) designed to contain products for pressing and delimited by at least a pressing wall (400, 401, 405) rotatingly and alternatingly mobile between an initial position and a final position such as to reduce a volume of the compartment (10) and press the contained products, and vice versa.

The present invention relates to a press and relative method for pressing food products, in particular for pressing grapes for the production of wine.

As is known, pressing causes the emission of wine must which is subsequently subjected to the necessary processes of fermentation and vinification.

Normally bunches of grapes are pressed more than once, each pressing stage being followed by a remixing stage, wherein the marc is remixed such that the grape juice can be more thoroughly extracted.

In principle, must obtained during a first pressing stage is generally more highly valued and used for higher quality products, compared to must obtained during subsequent pressing stages.

Currently, grapes are pressed using specific presses which can be categorized as vertical presses or horizontal presses.

Vertical presses generally comprise a lower container with an upward facing concavity for containing bunches of grapes, and an upper cover, associated to hydraulic and mechanical drive means, designed to close and slide vertically inside the opening of the lower container such as to press the grapes contained therein.

A disadvantage of vertical presses is that the remixing stages of the marc must be conducted manually, for example using forks or similar instruments. Horizontal presses differ from vertical presses by comprising a horizontally-extending external casing, and horizontal presses can be further sub-categorized into membrane presses and plate presses.

Membrane presses generally comprise a horizontal-axis cylindrical casing, an internal volume thereof being divided into two sub-compartments by a deformable membrane, of which a first sub compartment being designed for the insertion of grapes, and a second sub-compartment being connected to suitable compressed air supply means, the compressed air inducing an expansion of the membrane such as to press the grapes contained inside the first sub-compartment.

Plate presses generally comprise a sliding piston (pressing plate) axially inserted into a horizontally-extending external casing, such as to internally delimit a compartment of variable volume designed to contain the grapes to be pressed.

The sliding piston is mobile from an initial position to a final position such as to progressively reduce the volume of the internal compartment, pressing the contained products against an end portion of the external casing.

In horizontal presses the remixing of the marc is normally achieved by rotating the external casing about its horizontal axis.

Sometimes the pressing process produces relatively compact agglomerations of marc that do not break up during rotation, preventing or at least reducing the effectiveness of the remixing stage.

In order to obviate this disadvantage a modified horizontal plate press has been developed.

The modified horizontal plate press comprises a fixed external casing of constant rectangular transversal cross-section exhibiting flat upper and lower walls.

The upper wall is openable such as to permit the insertion of the grapes, which accumulate on the lower wall.

The lower wall is openable such as to permit the removal of the marc following pressing.

The pressing plate of the modified horizontal press is inclined from the top to the bottom in the direction in which grape pressing occurs.

In this way, when the pressing plate withdraws after pressing, the marc falls back onto the lower wall, disentangling and remixing.

However, this modified horizontal press is not without drawbacks.

In particular, as a consequence of the rectilinear movement of the pressing plate the overall bulk of the press is relatively large in relation to the loading capacity, loading capacity being the quantity of grapes loadable into the internal compartment of the press during each pressing cycle.

Furthermore, the loading of grapes through the upper wall of the external casing results in the grapes dropping a considerable distance before reaching the lower wall and the resulting impact damages the grape skins and stones, sometimes causing a release of unwanted substances which disperse in the must and reduce its quality.

An aim of the present invention is to provide a press for pressing food products, in particular for pressing grapes, which obviates the drawbacks of both vertical presses and horizontal presses.

A further aim of the invention is to attain the aim stated above by way of a simple, rational nd relatively inexpensive solution.

These aims are attained by the characteristics of the invention as described in the independent claims. The dependent claims delineate preferred and/or particularly advantageous embodiments of the invention.

In particular, the invention provides a press comprising a compartment designed to contain products for pressing, the compartment being delimited by at least a pressing wall rotatably and alernatingly mobile between an initial position and a final position such as to reduce the internal volume of the compartment and press the contained products, and vice versa.

The rotational movement of the pressing wall results in the press being very compact and, for the same loading capacity, exhibiting reduced overall bulk relative to existing horizontal presses.

In a preferred embodiment of the invention, the rotary movement of the pressing wall is about a horizontal axis of rotation.

As a consequence of this solution, after pressing, the pressing wall can move to a position in which the marc falls onto the lower wall, breaking up any agglomerations and ensuring an effective remixing of the marc.

In a further preferred embodiment of the invention, the rotary movement of the pressing wall during pressing is a movement upwards from below.

This arrangement provides improved and more effective loading of products for pressing.

A pressing method of the invention includes a preliminary positioning of the pressing wall in a raised position relative to the initial position, such as to be in proximity of a loading opening for the entry of products and thereby minimizing the distance that products fall when entering the pressing compartment.

As products gradually accumulate, the pressing wall is progressively lowered towards the initial position, such as to complete the descent of the products and simultaneously liberate further space inside the press.

Finally, the compartment is closed and the pressing wall is rotated and raised towards the final position, pressing the products contained inside the compartment.

The pressing stage can be repeated more than once if necessary before opening the compartment for the removal of the solid waste materials of pressing.

Further characteristics and advantages of the invention will better emerge from the detailed description made herein, provided by way of non-limiting example in the accompanying figures of the drawings.

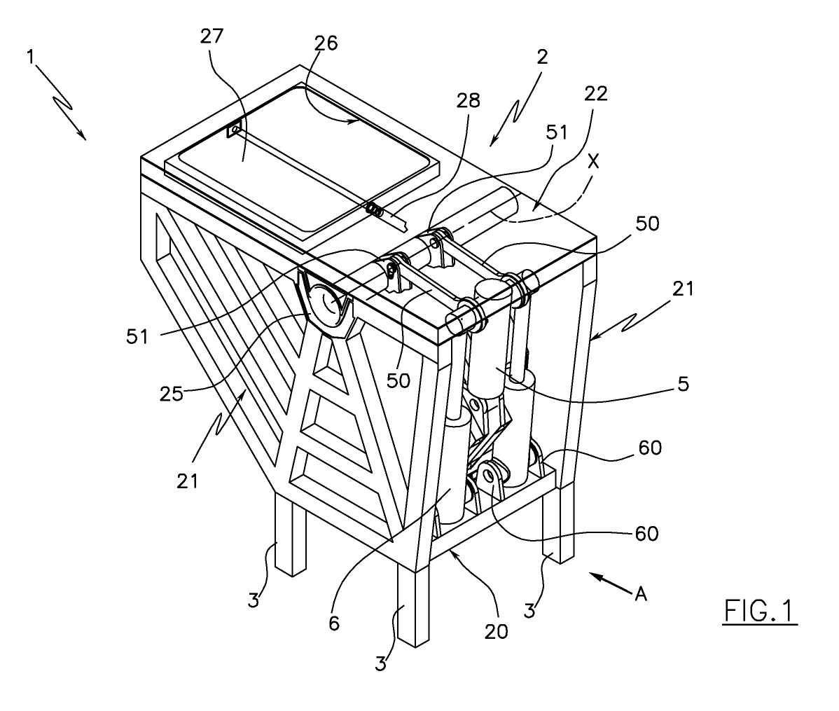

FIG. 1 is a perspective view of a press for pressing food products of the invention.

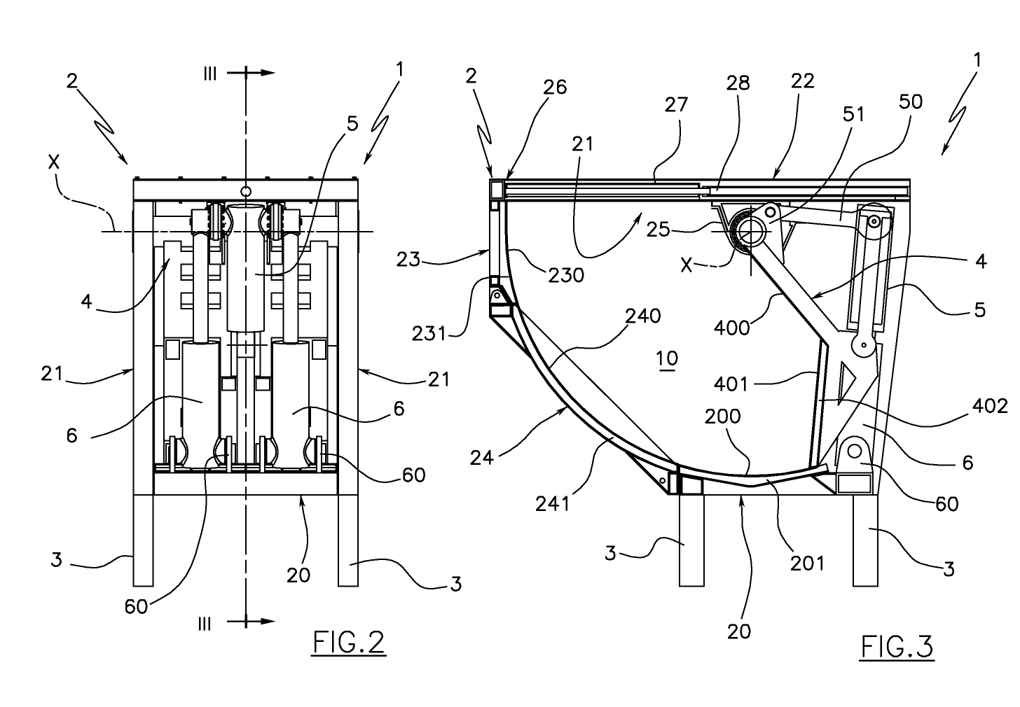

FIG. 2 is a view indicated as A in FIG. 1.

FIG. 3 is cross-section III-III of FIG. 2.

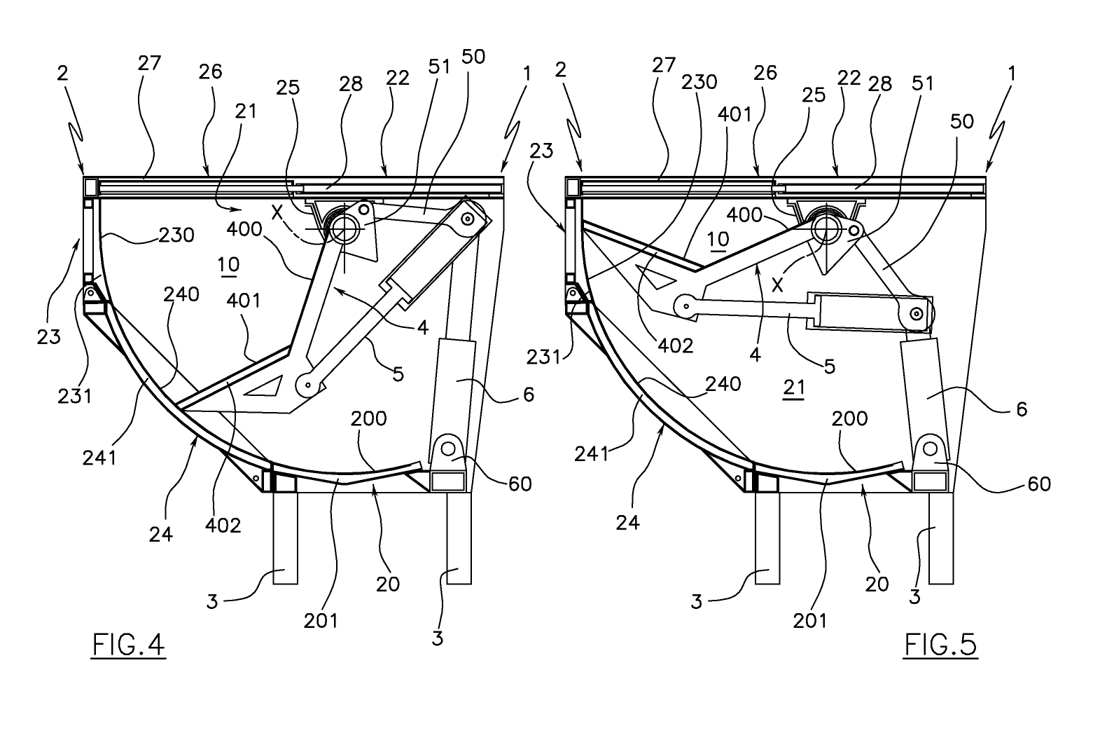

FIGS. 4 to 7 are cross-sections of FIG. 3 illustrating the press in four different configurations.

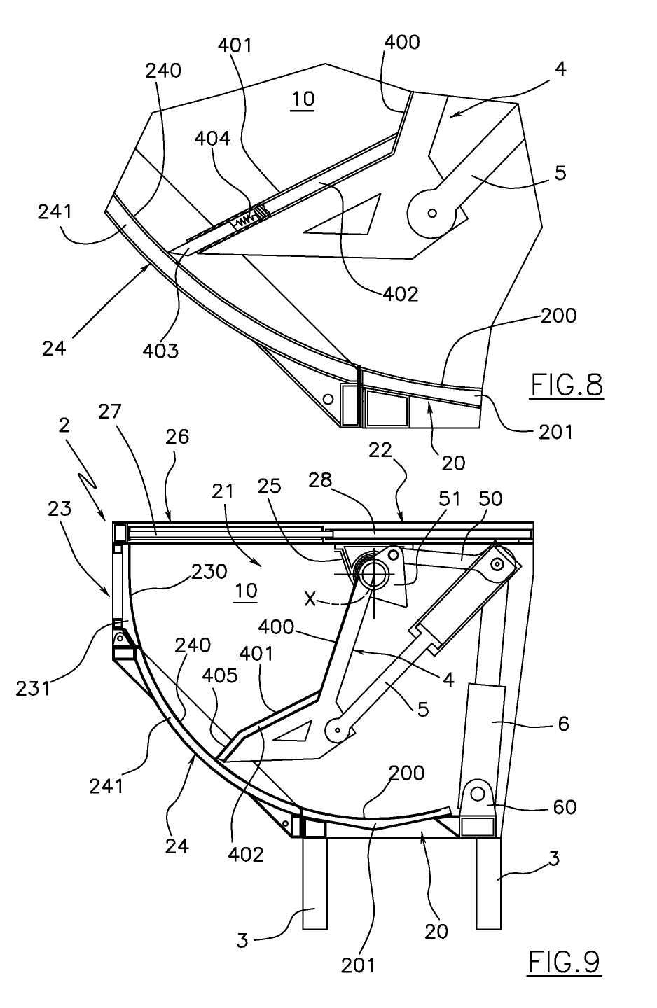

FIG. 8 is an enlarged detail of a first embodiment of the press of 1.

FIG. 9 illustrates a second variant of the press of FIG. 1.

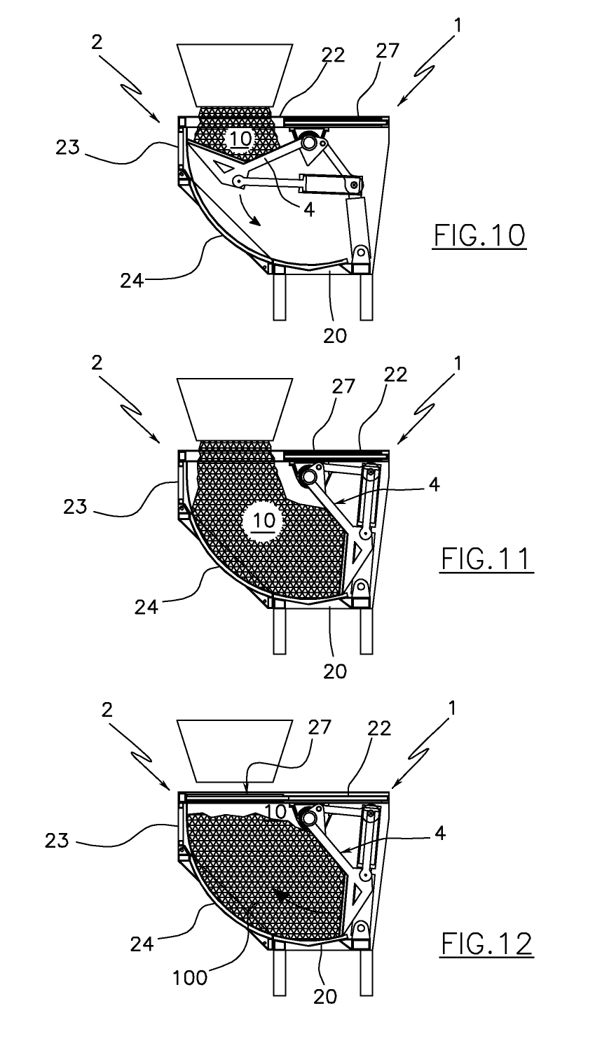

FIGS. 10 to 19 are cross-sections of FIG. 3 in reduced scale and illustrating ten successive stages in the operation of the press.

The press 1 comprises an external casing, denoted in its entirety by 2, supported on a series of ground-bearing legs 3.

The casing 2 comprises a lower base 20 to which are fitted two identical vertical walls 21 of substantially trapezoidal shape, the longest side thereof positioned facing upwards, the vertical walls 21 being reciprocally opposite each other and separated by a distance equal to the width of the lower base 20.

Upper ends of the vertical walls 21 support an upper horizontal wall 22, which overlies the lower base 20 such as to delimit, together with the lower base 20 and the vertical walls 21, an internal compartment 10.

As illustrated in FIG. 3, the forward side of the internal compartment 10 is closed by a vertical wall 23 and by a lower hatch 24 which follow the profile of the vertical walls 21.

The vertical wall 23 is solidly fixed to the vertical walls 21 and to the horizontal upper wall 22.

The lower hatch 24 is hinged to the lower end of the vertical wall 23, rotating about a horizontal axis which permits the lower hatch 24 to be rotatingly moved downwards, between a closed position of FIG. 3 and an open position of FIG. 7, and vice versa.

Associated to the lower hatch 24 are releasable means for locking, designed to maintain the door normally in a closed position, together with means for sealing, designed to hermetically seal the internal compartment 10 when the lower hatch 24 is in the closed position.

Naturally, the hatch 24 could be connected to the press using any other mechanism which permits opening and closing of the internal compartment 10, for example using a four-bar linkage mechanism.

The rear side of the internal compartment 10 is closed by an oscillating frame 4, the upper end thereof being hinged to the vertical walls 21, along a horizontal axis of rotation X, using a pair of coaxial supports 25 positioned in proximity of the horizontal upper wall 22.

In this way, the oscillating frame 4 can move from an initial position illustrated in FIG. 3, rotating upwards on the supports 25, until reaching a final position illustrated in FIG. 5, and vice versa.

During rotation from the initial position to the final position, the oscillating frame 4 progressively reduces the volume of the internal compartment 10. The rotation of the oscillating frame 4 is activated in both directions by three hydraulic jacks fitted outside the internal compartment 10.

In general, each jack comprises a piston which slides inside a cylinder in response to a pressure transmitted and exerted by hydraulic fluid. When reference is made herein below to “the end of a jack” this is intended as the free end of a piston and the opposite end of the relevant cylinder. Likewise, a jack will be referred to as being in a “short configuration” when the piston is inserted to the maximum into the cylinder, and similarly a jack will be referred to as being in a “long configuration” when the piston is extracted to the maximum.

A first activating jack 5 exhibits an end articulated to the oscillating frame 4 and an opposite end articulated to two connecting arms 50 (see also FIG. 1). The axes of articulation of the activating jack 5 with the oscillating frame 4 and connecting arms 50 are both parallel to the axis of rotation X.

The connecting arms 50 are fixed to respective pairs of support brackets 51, which rotate about the axis of rotation X of the oscillating frame 4.

In more detail, the support brackets 51 are solidly attached to the oscillating frame 4 and the connecting arms 50 are articulated to the support brackets 51 on an axis of rotation parallel to the axis of rotation X.

The remaining activating jacks 6 are positioned opposite the first jack 5.

Each jack 6 exhibits an end articulated to a pair of support brackets 60, which are solidly fixed to a cross-member of the lower base 20, and an opposite end of each jack 6 is directly articulated to the first jack 5.

In particular, the axes of articulation of each jack 6 with the support brackets 60, are coincident to each other and parallel to the axis of rotation X, while the axes of articulation of each jack 6 with the first jack 5 coincide exactly with the axis of articulation of the first jack 5 with relative connecting arms 50. The jacks 6 are therefore perfectly symmetrical and exert an identical action, such that they could theoretically be substituted by a single jack applying a double force.

As illustrated in FIGS. 2 and 3, the activating jacks 5 and 6 are installed such that when the oscillating frame 4 is in the initial position, the first jack 5 is in the short configuration and the second jacks 6 are in the long configuration.

The rotating of the oscillating frame 4 towards the final position can initially be achieved by the extension of only the first jack 5, maintaining the jacks 6 locked in the long configuration, until the intermediate position of FIG. 4 is reached, then maintaining the first jack 5 in the long configuration, and shortening the jacks 6 until the final position of FIG. 5 is reached.

Naturally, the activation of jacks 5 and 6 can also be simultaneous and coordinated, and can be interrupted at any time in order to stop the oscillating frame 4 in any intermediate position between the initial and final positions.

The activation of the jacks 5 and 6 can also be inverted in order to move the oscillating frame 4 in a reverse direction from the final position towards the initial position.

In more detail, the upper wall 22 of the external casing 2 comprises a composite panel, which generally comprises a tubular internal frame (not visible) which is entirely covered both internally and externally by stainless steel plate completely impermeable to liquids.

The steel plates of the upper wall 22 exhibit two identical openings reciprocally aligned and together forming a passage 26 connecting the internal compartment 10 to the external environment.

An upper hatch 27 is also slidingly attached to the frame of the upper wall 22.

The upper hatch 27 is also made from a composite panel comprising a tubular frame (not visible) covered both internally and externally in impermeable stainless steel plate, but the upper hatch 27 is of minor thickness compared to the thickness of the upper wall 22.

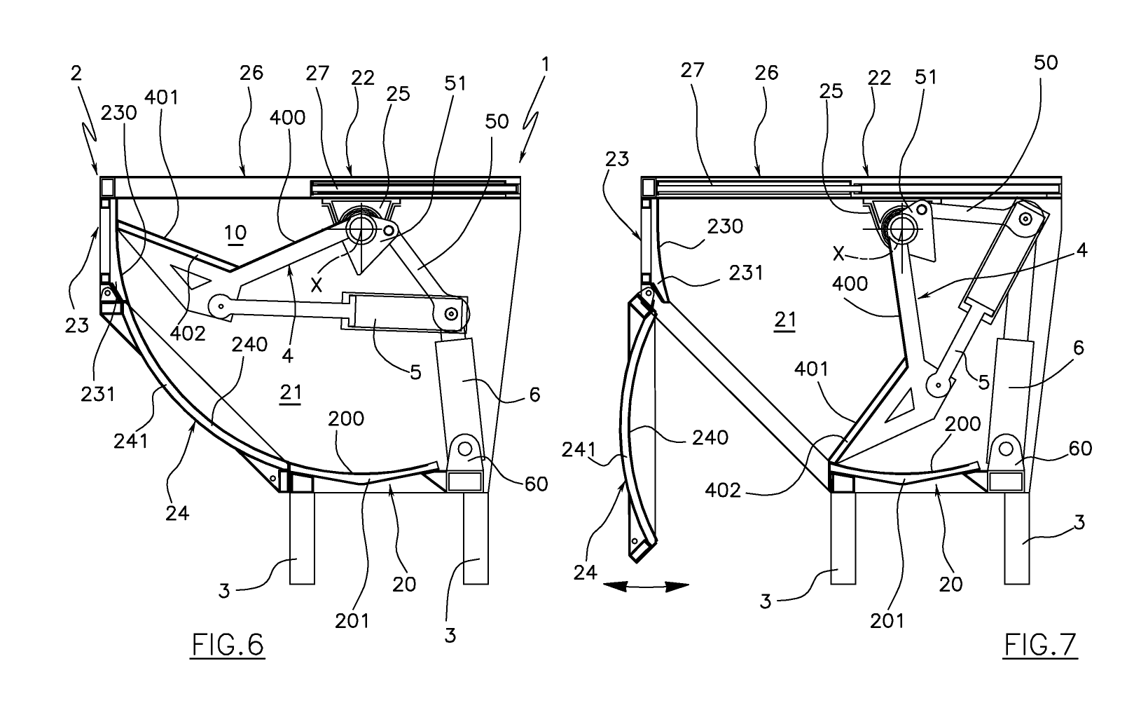

In this way, the upper hatch 27 slides coplanar between the steel plates covering the frame of the upper wall 22, moving between a closed position illustrated in FIG. 3, in which the passage 26 is completely closed, and an open position illustrated in FIG. 6, in which the passage 26 is left open, and vice versa.

The sliding of the upper hatch 27 is activated in both directions by a single hydraulic jack 28, the cylinder of which is installed between the steel plates of the upper wall 22, while the relative piston is fixed to the distal side of the upper hatch 27.

Also associated to the upper hatch 27 are means for sealing, designed to ensure a hermetic closure of the passage 26 when the hatch 27 is in the closed position.

As illustrated in FIG. 3, the lower base 20 of the external casing 2 comprises a support frame internally covered by stainless steel plate 200 designed to delimit the internal compartment 10.

The steel plate 200 extends transversally for the entire distance separating the vertical walls 21 and exhibits a curved transverse profile.

The steel plate 200 is perforated such as to retain the solid phase contained in the internal compartment 10, while permitting passage of the liquid phase. On the back of the steel plate 200, on the external face relative to the internal compartment 10, a collector 201 is fashioned, designed to collect and convey the liquid phase that passes through the steel plate 200 towards an appropriate area at the bottom of the casing 2, where means for releasing are provided (not illustrated).

The lower hatch 24 comprises a support frame internally covered by a stainless steel plate 240 designed to delimit the internal compartment 10.

The steel plate 240 extends transversally for the entire distance between the vertical walls 21, and exhibits an arched transverse section exhibiting a same centre of curvature and radius of curvature as the plate 200, and defining a substantially continuous surface with the surface of the plate 200.

The steel plate 240 is perforated such as to retain the solid phase contained in the internal compartment 10, while permitting the passage of the liquid phase.

Fashioned on the back of the steel plate 240 is a channelling system 241 designed to receive and channel the liquid phase, which passes through the steel plate 240, into the collector 201.

The vertical wall 23 also comprises a support frame covered internally by a stainless steel plate 230 designed to delimit the internal compartment 10.

The steel plate 230 extends transversally for the entire distance between the vertical walls 21, and exhibits a curved transverse profile of the same centre of curvature and axis of curvature as the plate 240, with a surface of which plate 240 it defines a substantially continuous surface.

The steel plate 230 is perforated such as to retain the solid phase contained in the internal compartment 10, while permitting the passage of the liquid phase.

Fashioned on the back of the steel plate 230 is a channelling system 231 designed to receive and channel the liquid phase that passes through the steel plate 230 into the channelling system 241, and subsequently into the collector 201.

Note that the centre of curvature of the perforated plates 200, 240, and 230 coincide with the axis of rotation X of the oscillating frame 4 and that the radius of curvature of the perforated plates 200, 240, and 230 is equal to the radial distance separating the axis of rotation X from the distal end of the oscillating frame 4.

In this way, during rotation the oscillating frame 4 always remains in contact with the perforated plates 200, 240, 230 ensuring the closure of the internal compartment 10.

As in the previous cases, the vertical walls 21 too are individually comprised of an external support frame internally covered by one or more sheets of stainless steel plate such as to form a continuous surface that delimitates the internal compartment 10.

The steel plate is perforated such as to retain the solid phase contained in the internal compartment 10, permitting the passage of the liquid phase which flows into a channelling system located to the rear and which conveys the liquid phase into the collector 201.

The perforations in the plate covering the vertical walls 21 are not illustrated in the figures because the density of detail would render the figures difficult to understand.

The oscillating frame 4 comprises a rear supporting structure to which the activating jacks 5 and 6 are fitted, the supporting structure being covered by two stainless steel plates 400 and 401 positioned alongside each other such as to define a single surface delimiting the internal compartment 10.

The steel plates 400 and 401 extend transversally for the entire distance separating the vertical walls 21, and exhibit a rectilinear transverse profile. The steel plates 400 and 401 are reciprocally inclined relative to each other such that the surface delimiting the internal compartment 10 exhibits a central cavity facing towards the inside of the compartment 10.

The upper steel plate 400 is completely impermeable to liquids.

The lower steel plate 401 is perforated such as to retain the solid phase contained in the internal compartment 10 while allowing the liquid phase to pass through.

On the back of the lower steel plate 401 a channelling system 402 is fashioned, which is destined to receive the liquid phase passing through the steel plate 401 and convey the liquid towards the distal end of the oscillating frame 4 from where the liquid runs onto the perforated walls 200, 240, or 230. In the variant illustrated in FIG. 8, the distal end of the oscillating frame 4 is defined by a blade 403 oriented parallel to the lower steel plate 401.

The blade 403 extends transversally over the entire distance separating the vertical walls 21 and is housed in a relative seating formed on the back of the lower plate 401, internally of which the blade 403 can slide backwards and forwards while always remaining parallel to the lower steel plate 401.

The blade 403 is continuously pushed towards the outside by a spring 404 housed in the seat.

During rotation of the oscillating frame 4, the blade 403 slides in contact with the perforated plates 200, 240, or 230, and is free to move on the oscillating frame 4 in a transverse direction relative to the plates 200, 240, and 230.

In this way, the blade 403 ensures the closure of the internal compartment 10, compensating any errors in the curvature of the plates 200, 240, and 230 which otherwise might result in blockage of the oscillating frame 4, and at the same time acting as a scraper, preventing the accumulation on the perforated plates 200, 240, and 230 of compressed product which could obstruct the perforations.

In the variant illustrated in FIG. 9, the distal end of the oscillating frame 4 is defined by a third steel plate 405, which extends transversally for the entire distance separating the vertical walls 21, and together with the steel plates 400 and 401 defines a single surface delimiting the internal compartment 10. The steel plate 405 exhibits a rectilinear transverse profile and is inclined relative to the adjacent steel wall 401, such as to define with the steel wall 401 a concavity facing towards the outside of the compartment 10.

The steel plate 405 is perforated such as to retain the solid phase contained in the internal compartment 10, while permitting passage of the liquid phase.

A channelling system 402, destined to receive the liquid phase that passes through the plate 405, extends over the back of the steel plate 405 and conveys the liquid phase towards an outlet from where it runs onto the perforated walls 200, 240, or 230.

The blade 403 described herein above can be associated to the steel plate 405.

While all the examples illustrate a wall defined in its entirety by the steel plates of the oscillating frame 4 exhibiting a complex profile, it is not to be excluded that the wall might exhibit a perfectly linear profile.

All pressing procedures begin with the press 1 in the configuration illustrated in FIG. 10, wherein the lower hatch 24 is closed, the upper hatch 27 is open and the oscillating frame 4 is in the final position.

The bunches of grapes drop from a hopper into the internal compartment 10 through the passage 26, the grapes falling directly onto the plates 400 and 401 of the oscillating frame 4.

As the grapes gradually fill the internal compartment 10, the oscillating frame 4 is activated to move downwards towards the initial position (FIG. 11), such as to progressively lower the grapes and free more space for the entry of an increasing volume of grapes.

This movement of the oscillating frame 4 prevents damage to the grapes during the loading stage.

When the loading phase is complete, the upper hatch 27 is closed as shown in FIG. 12, completely isolating the load 100 of grapes inside the compartment 10, after which the first pressing stage begins.

The oscillating frame 4 is driven in rotation about the axis X between the initial position of FIG. 10 towards the final position, progressively reducing the volume of the internal compartment 10 and consequently pressing the load 100 of grapes upwards from below against the upper wall 22.

The pressing causes the crushing of the grapes and the extraction of the juice, which can flow through the perforated plates 200, 230, 240, and 400 into the relative systems of channelling and collection 201, 231, 241, and 402, finally reaching outlet means located on the bottom of the external casing 2.

Obviously, the juice can also flow through the perforated plates of the vertical walls 21 and through the relative channelling behind the vertical walls 21.

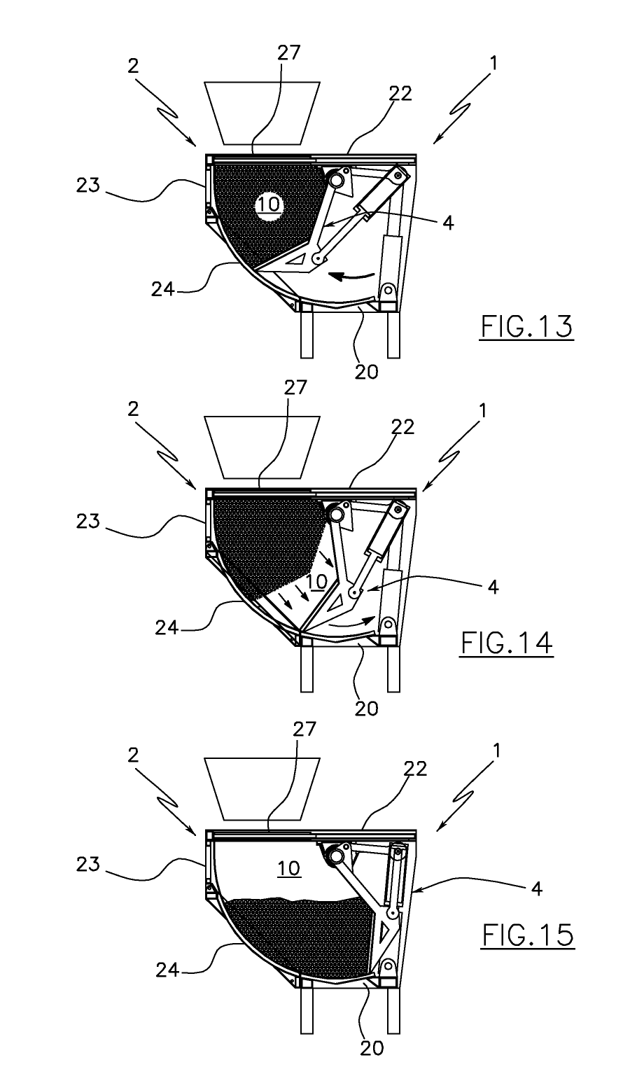

The first pressing cycle ends when the oscillating frame 4 reaches an intermediate position between the initial and the final position, as illustrated for example in FIG. 13, such as not to excessively compress the bunches of grapes and thus obtain a high quality must.

The marc, the solid phase of the grapes (skins and seeds), remains inside the compartment 10 and therefore compacted by the oscillating frame 4 against the upper wall 22.

The oscillating frame 4 is then driven to move back towards the initial position as illustrated in FIG. 14.

The marc does not immediately follow the return movement of the oscillating frame 4 and the portion that remains momentarily suspended tends to fall by gravity to the bottom of the compartment 10, disentangling and producing a progressive mixing of the marc, until achieving the configuration illustrated in FIG. 15.

Subsequently the oscillating frame 4 performs further pressing cycles, during which the oscillating frame 4 can be stopped in intermediate positions increasingly closer to the final position. The further pressing cycles are always followed by a return movement to the initial position, such as to remix the pressed product as described above.

During the pressing cycles, the concave profile formed by the plates 400 and 401 permit the oscillating frame 4 to accumulate the majority of the grapes centrally for pressing against the upper hatch 27.

The convex profile defined by the plates 405 and 401 in the embodiment of FIG. 9, instead permits the oscillating frame 4 to push and press at least a part of the grapes against the side and base walls 200, 240, and 230.

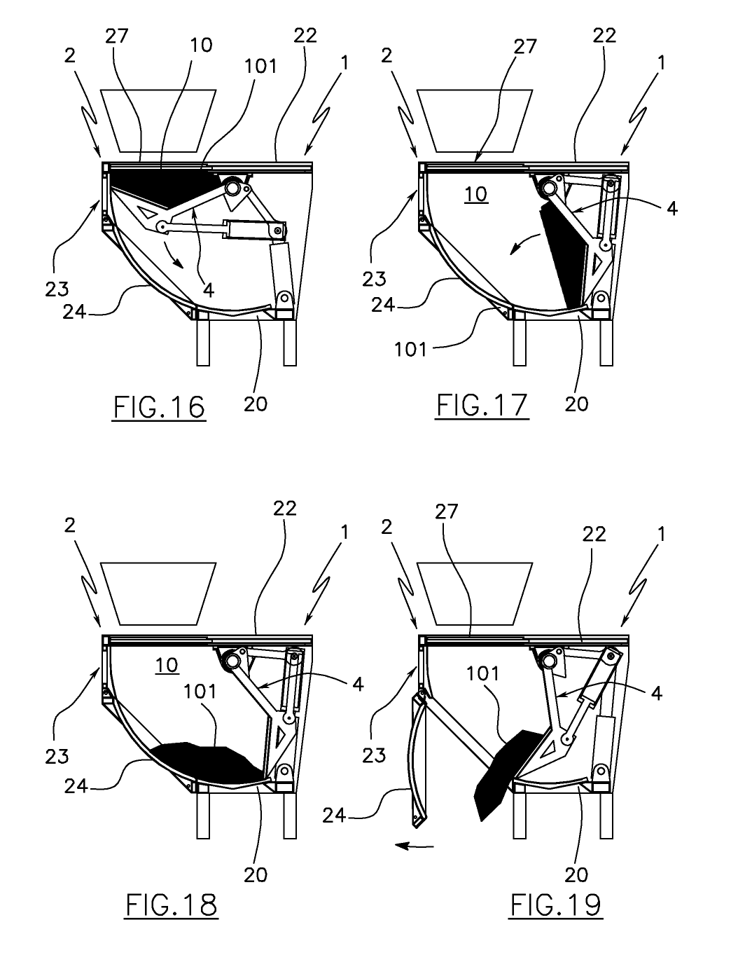

As mentioned, the final pressing cycles can continue until the oscillating frame 4 is in the final position, as illustrated in FIG. 16.

During the final pressing cycles, the marc that remains inside the compartment 10 forms a relatively compact agglomeration 101 against the upper wall 22.

When the oscillating frame 4 is activated to move back towards the initial position, this agglomeration 101 of marc can follow the movement, remaining supported on the plates 400 and 401.

Since the plates 400 and 401 define a concavity, the agglomeration 101 remains associated to the oscillating frame 4 substantially until the oscillating frame 4 reaches the initial position, as illustrated in FIG. 17.

In this position, the barycentric axis of the agglomeration 101 falls outside the plates 400 and 401, such that the agglomeration 101 collapses backwards disintegrating and collecting on the curved plates 200 and 240 that define the base of the internal compartment 10, as illustrated in FIG. 18.

This collapse ensures an effective remixing of the product which can subsequently be subjected to further pressing cycles by the oscillating frame 4, until complete juice extraction is achieved.

Obviously, the must obtained during the initial pressing stages is generally more highly valued and consequently used for higher quality products, compared to the must obtained during subsequent pressing stages.

When the pressing process is complete, the lower hatch 24 is opened and the oscillating frame 4 is moved into the intermediate position illustrated in FIG. 19, such as to unload the residual marc outside the compartment 10.

In a possible variant of the invention the press 1 comprises a deformable membrane designed to further compress the bunches of grapes in the internal compartment 10 when the oscillating frame 4 is in the final position.

The membrane could be associated to the lower face of the upper hatch 27, on the condition that the upper hatch 27 affords for example a series of through holes connected to means for supplying compressed air.

In this way, the membrane would normally assume a non-deformed configuration wherein the membrane lies on the lower surface of the hatch 27, such as to consent the latter to slide between the open and closed positions, and the membrane could also be inflated using compressed air when the hatch 27 is in the closed position, such as to expand towards the inside of the compartment 10 further compressing the grapes contained in the compartment 10.

Alternatively, the membrane could be associated to the perforated plate 401 of the oscillating frame 4, on the condition for example that the channelling system 402 positioned to the rear is placed in communication with means for supplying compressed air.

In this way the membrane would normally assume a non deformed configuration wherein the membrane lies on the perforated plate 401, and could also be inflated with compressed air such as to deform towards the inside of the compartment 10, further compressing the grapes contained in the compartment 10.

The deformable membrane must naturally be impermeable, such that the draining of the must would only be possible through the perforated plates 230, 240, and 200.

In another alternative embodiment of the invention the press 1 comprises means (of known type) for inserting one or more inert gasses into the compartment 10, such as to conduct pressing operations in a protected anti-oxidizing atmosphere and consequently improving the quality of the must.

Obviously a technical expert in the sector could introduce numerous modifications of a practical-technical nature to the press 1 as described above, without forsaking the ambit of the invention as claimed below.

Although the press 1 is described for pressing grapes, it is not excluded that the press 1 could be used for pressing other fruit, and more in general for pressing other food products.

1). A press for pressing food products, comprising a compartment (10) designed to contain products for pressing and delimited by at least a pressing wall (400, 401, 405) which is mobile and exhibits an alternating movement from an initial position towards a final position such as to reduce the volume of the compartment (10) and press the contained products, and vice versa, characterized in that the alternating movement of the pressing wall (400, 401, 405) between the initial position and the final position is a rotary movement.

2). The press of claim 1, characterized in that the rotary movement is about a horizontal axis of rotation.

3). The press of claim 2, characterized in that during the rotary movement from the initial position towards the final position, the pressing wall (400, 401, 405) performs an upward movement.

4). The press of claim 3, characterized in that it comprises a loading hatch (26), positioned above the pressing wall (400, 401, 405) when the pressing wall (400, 401, 405) is in the final position, and through which the product to be pressed can be inserted into the compartment (10) under the force of gravity.

5). The press of claim 1, characterized in that the pressing wall (400, 401, 405) exhibits a concave central portion, a concavity thereof facing internally of the compartment (10).

6). The press of claim 1, characterized in that an end of the pressing wall (400, 401, 405) exhibits a convex end portion, a concavity thereof facing towards an outside of the compartment (10).

7). The press of claim 1, characterized in that the compartment (10) is at least partially delimited by one or more filtering surfaces (200, 230, 240, 401, 405) destined to permit passage of at least a liquid phase of the pressed grapes.

8). The press of claim 7, characterized in that at least one of the filter surfaces (401, 405) is associated to the pressing wall.

9). The press of claim 7, characterized in that it comprises conveying means (201, 231, 241, 402) destined to receive and convey the liquid phase passing through the filtering surfaces (200, 230, 240, 400) towards discharge means thereof.

10). The press of claim 1, characterized in that when the pressing wall (400, 401) is in the final position, the compartment (10) is at least partially delimited by a deformable membrane associated to means designed to inflate the membrane such as to further reduce the volume of the compartment (10).

11). The press of claim 10, characterized in that the at least a deformable membrane is associated to the pressing wall (400, 401).

12). The press of claim 10, characterized in that the at least a deformable membrane is associated to an openable hatch (27) through which the product to be pressed is introduced into the compartment (10).

13). The press of claim 1, characterized in that it comprises a contact body (403) associated to the pressing wall (400, 401, 405), such as to slide in contact with a fixed wall (200, 230, 240) of the compartment (10) during movements of the pressing wall, the contact body (403) being mobile in relation to the pressing wall (400, 401) in a transverse direction to the fixed wall (200, 230, 240).

14). The press of claim 1, characterized in that it comprises means for inserting into the compartment (10) one or more gases such as to form a protective atmosphere.

15). A method for pressing food products using the press of claim 3, characterized in that it comprises stages of:
positioning the pressing wall (400, 401) in a raised position in relation to the initial position,
introducing products to be pressed (100) into the compartment (10) while the pressing wall (400, 401) is lowered towards the initial position,
closing the compartment (10), and
rotating the pressing wall (400, 401) from the initial position towards the final position, such as to press the products contained in the compartment (10).

16). The method of claim 15, characterized in that the pressing stage is repeated before opening the compartment (10) in order to unload the solid residue of the pressing.
